(19) United States
(12) Patent Application Publication
(10) Pub. No.: US 2019/0309192 A1
(43) Pub. Date: Oct. 10, 2019

(54) NON-DESTRUCTIVE ADHESIVE STRIP SYSTEM AND METHOD

(71) Applicant: Merdene Connell, Brooklyn, NY (US)

(72) Inventor: Merdene Connell, Brooklyn, NY (US)

(21) Appl. No.: 16/180,611

(22) Filed: Nov. 5, 2018

Related U.S. Application Data
(60) Provisional application No. 62/654,217, filed on Apr. 6, 2018.

(51) Int. Cl. C09J 7/21; C09J 7/40; C09J 7/38; C09J 5/00

(52) U.S. Cl. CPC C09J 7/21; C09J 7/405; C09J 2400/263; C09J 5/00; C09J 7/38

(57) ABSTRACT

An adhesive system includes an outer non-stick protective layer, a top adhesive layer, a middle support textile and a bottom adhesive layer. The adhesive system is useful for hanging paper materials without damaging those materials, or the surface where the materials are hung. This will allow the position of the materials to be adjusted for repeated use.

### CROSS-REFERENCE TO RELATED APPLICATION(S)

The present application is related to and claims priority to U.S. Provisional Patent Application No. 62/654,217 filed Apr. 6, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of adhesives of existing art and more specifically relates to surface bonding adhesives.

### RELATED ART

Paper materials including papers, posters, notices, and flyers are typically hung with standard pressure-sensitive tape. Regrettably it can be incredibly difficult to take down or remove these materials without ripping the corners or edges. Further, the pressure-sensitive tape also leaves residual adhesive on the surface where the material was placed and can cause damage to those surfaces. A suitable solution is desired.

U.S. Pub. No. 2014/0147625 to Da-Wei Lin relates to an adhesive double-sided tape. The described adhesive double-sided tape includes an adhesive double-sided tape that includes a base board, a first adhesive layer formed on one surface of the base board, and a second adhesive layer formed on another surface of the base board. The base board comprises a number of through holes. At least one of the first adhesive layer and the second adhesive layer is filled in the number of through holes to combine the first adhesive layer and the second adhesive layer together.

### SUMMARY OF THE INVENTION

In view of the foregoing disadvantages inherent in the known surface bonding adhesives art, the present disclosure provides a novel non-destructive adhesive strip system. The general purpose of the present disclosure, which will be described subsequently in greater detail, is to provide an efficient and effective non-destructive adhesive strip system.

An adhesive system is disclosed herein. The adhesive system includes an outer non-stick protective layer, a top adhesive layer, a middle support textile and a bottom adhesive layer. The top adhesive layer may be removably coupled to a bottom of the outer non-stick protective layer; a middle support textile may be fixedly attached to a bottom of the top adhesive layer; and a bottom adhesive layer may be fixedly attached to a bottom of the middle support textile. The outer non-stick protective layer, the top adhesive layer, the middle support textile, and the bottom adhesive layer may be configured to wind around a center cylindrical base. A portion of the bottom adhesive layer may then be removably attached to the outer non-stick protective layer of a next concentric layer; and the adhesive system may be configured to be dispensed from an outermost layer to an innermost layer from the center cylindrical base.

The top adhesive layer may be configured to have sufficient tensile strength to hold a sheet of paper and may be configured to be easily repositioned without damaging a surface where the top adhesive layer is attached. The bottom adhesive layer may be configured to have sufficient tensile strength to hold a sheet of paper and may be configured to be easily repositioned without damaging the surface where the bottom adhesive layer is attached. The outer non-stick protective layer may be configured to include functional indicia and may be configured to represent standard measurement markings.

The adhesive system may be configured to be easily cut in desired user-determined lengths, may be reusable, and is configured to be designed with non-toxic material. The adhesive system may be configured to be dispensed in measured sections that may coincide with the standard measurement markings. The middle support textile may be configured to be perforated for easy removal when the adhesive system is configured in the measured sections. The perforation of the middle support textile may be configured to run perpendicular to the adhesive system. The adhesive system may be configured to be of sufficient length to hold at least three feet of the adhesive system. Alternately, the adhesive system may be configured to be dispensed in one continuous length.

According to another embodiment, a method for using a non-destructive adhesive system is also disclosed herein. The method for using a non-destructive adhesive system includes providing a non-destructive adhesive system, measuring a section of the non-destructive adhesive system, tearing off the section of the non-destructive adhesive system, placing the section of the non-destructive adhesive system on an item, hanging the item once the non-destructive adhesive system is placed, and adjusting the non-destructive adhesive system.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a non-destructive adhesive strip system, constructed and operative according to the teachings of the present disclosure.

FIG. 1 is a perspective view of the adhesive system during an ‘in-use’ condition, according to an embodiment of the disclosure.

FIG. 2 is a perspective view of the adhesive system of FIG. 1, according to an embodiment of the present disclosure.

FIG. 3 is a perspective view of the adhesive system of FIG. 1, according to an embodiment of the present disclosure.

FIG. 4 is a side view of the adhesive system of FIG. 1, according to an embodiment of the present disclosure.

FIG. 5 is a flow diagram illustrating a method of using the non-destructive adhesive system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to surface bonding adhesives and more particularly to a non-destructive adhesive strip system as used to improve hanging means for paper materials without damaging those materials, or the surface where the materials may be hung. This may allow the position of the materials to be adjusted for repeated use.

Generally, the adhesive tape may be used to mount paper displays such as posters, charts, etc. This can replace the use of pins and can be used on any surface. The adhesive tape may be removed and repositioned without leaving residual adhesive that may damage the display and the surface where the display was originally positioned.

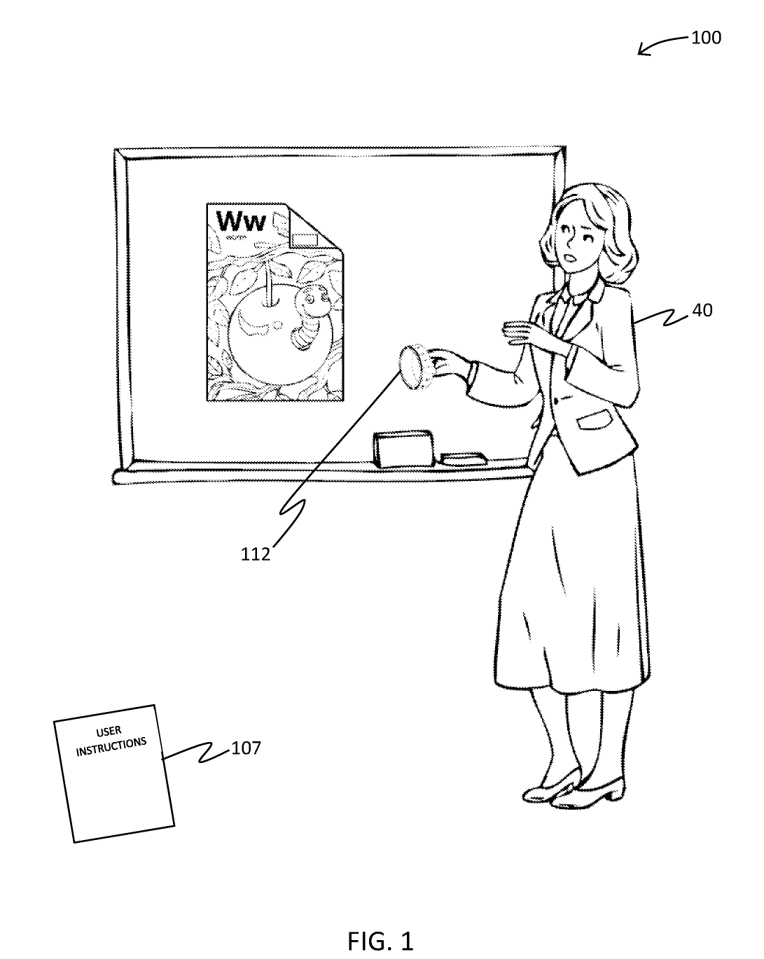

Referring now more specifically to the drawings by numerals of reference, there is shown in FIGS. 1-4, various views of an adhesive system 100.

FIG. 1 shows an adhesive system 100 during an ‘in-use’ condition 50, according to an embodiment of the present disclosure. Here, the adhesive system 100 may be beneficial for use by a user 40 to hang paper materials without damaging those materials, or the surface where the materials may be hung. As illustrated, the adhesive system 100 may include an outer non-stick protective layer 110, a top adhesive layer 120, a middle support textile 130 and a bottom adhesive layer 140. The outer non-stick protective layer 110 may be configured to include functional indicia 112 and may be configured to represent standard measurement markings 10. The adhesive system 100 may be configured to be dispensed in measured sections that coincide with the standard measurement markings 10.

A top adhesive layer 120 may be removably coupled to a bottom 122 of the outer non-stick protective layer 110. The top adhesive layer 120 may be configured to have sufficient tensile strength to hold a sheet of paper and may be configured to be easily repositioned without damaging the surface where the top adhesive layer 120 is attached. A middle support textile 130 may be fixedly attached to a bottom 122 of the top adhesive layer 120. The middle support textile 130 may be configured to be perforated for easy removal when the adhesive system 100 is configured in the measured sections. The perforation may run perpendicular to the adhesive system 100. A bottom adhesive layer 140 may be fixedly attached to a bottom-side 132 of the middle support textile 130; wherein the bottom adhesive layer 140 is configured to have sufficient tensile strength to hold the sheet of paper and is configured to be easily repositioned without damaging the surface where the bottom adhesive layer 140 is attached.

The outer non-stick protective layer 110, the top adhesive layer 120, the middle support textile 130, and the bottom adhesive layer 140 may be configured to wind around a center cylindrical base 20. A portion of the bottom adhesive layer 140 may then be removably attached to the outer non-stick protective layer 110 of a next concentric layer 125. The adhesive system 100 may be configured to be designed with non-toxic material and reusable. The adhesive system 100 may be configured to be dispensed from an outermost layer 144 to an innermost layer 148 from the center cylindrical base 20. The adhesive system 100 may be configured to be of sufficient length to hold at least three feet of the adhesive system 100 and may be configured to be easily cut in desired user-determined lengths.

According to one embodiment, the adhesive system 100 may be arranged as a kit 105. In particular, the adhesive system 100 may further include a set of instructions 107. The instructions 107 may detail functional relationships in relation to the structure of the adhesive system 100 such that the adhesive system 100 can be used, maintained, or the like, in a preferred manner.

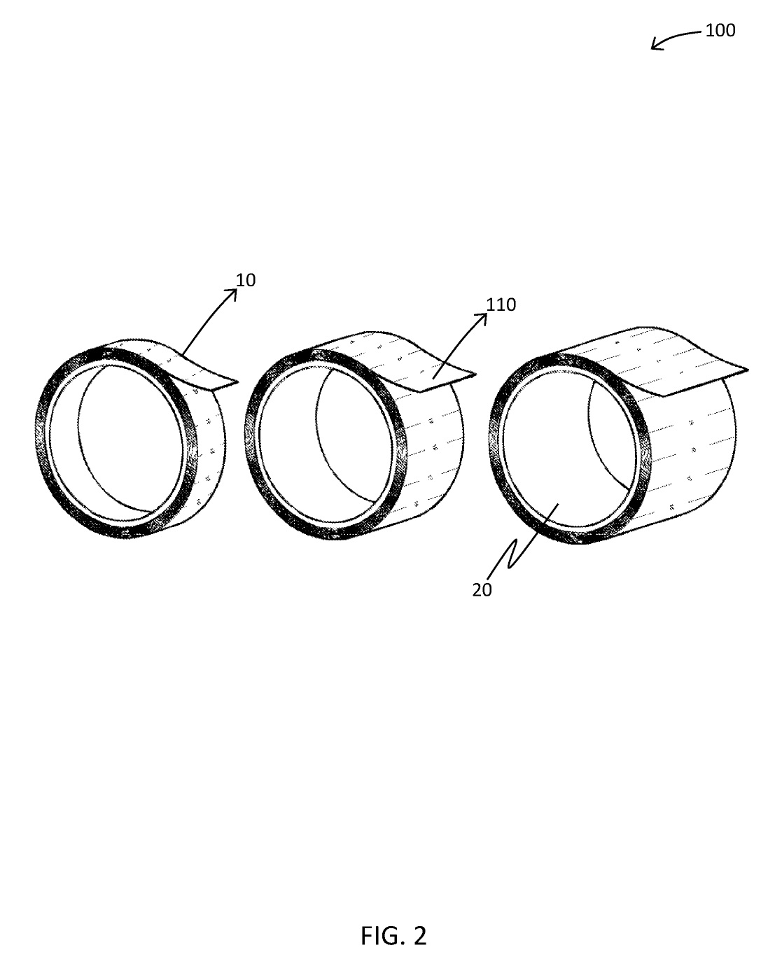

Referring now to FIG. 2 showing the adhesive system 100 of FIG. 1, according to an embodiment of the present disclosure. As above, the adhesive system 100 may include an outer non-stick protective layer 110, a top adhesive layer 120, a middle support textile 130 and a bottom adhesive layer 140. The outer non-stick protective layer 110 may include functional indicia 112 and may be configured to represent standard measurement markings 10. The adhesive system 100 may be configured to be dispensed in measured sections that coincide with the standard measurement markings 10.

The top adhesive layer 120 may be configured to have sufficient tensile strength to hold a sheet of paper and may be configured to be easily repositioned without damaging the surface where the top adhesive layer 120 is attached.

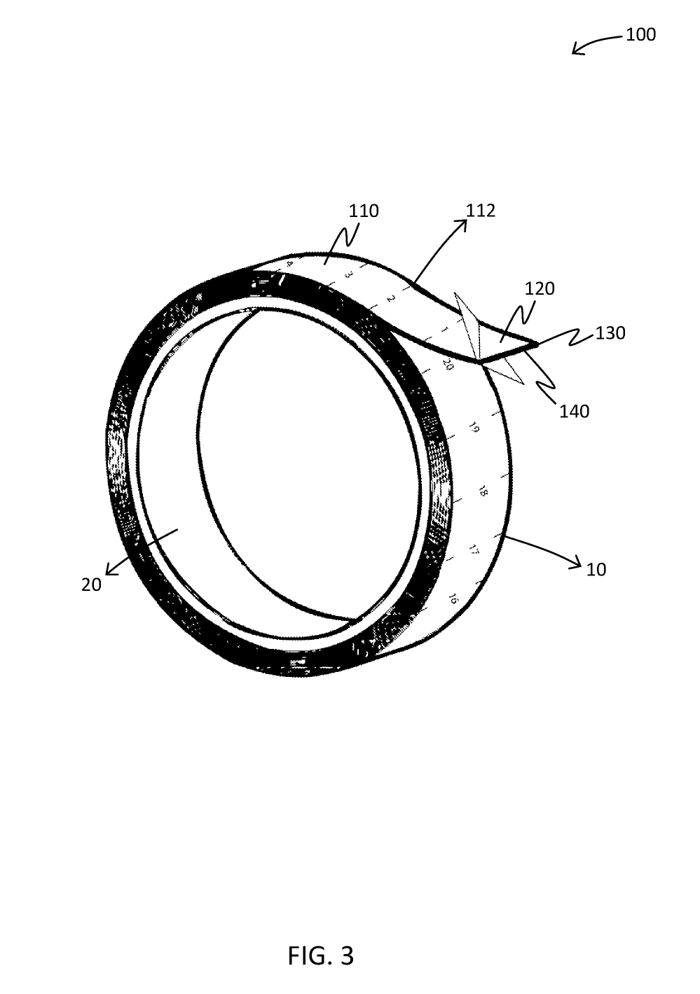

FIG. 3 is a perspective view of the adhesive system of FIG. 1, according to an embodiment of the present disclosure. The adhesive system 100 may be configured to be dispensed from an outermost layer 144 to an innermost layer 148 from the center cylindrical base 20. The adhesive system 100 may be configured to be of sufficient length to hold at least three feet of the adhesive system 100 and may be configured to be easily cut in desired user-determined lengths.

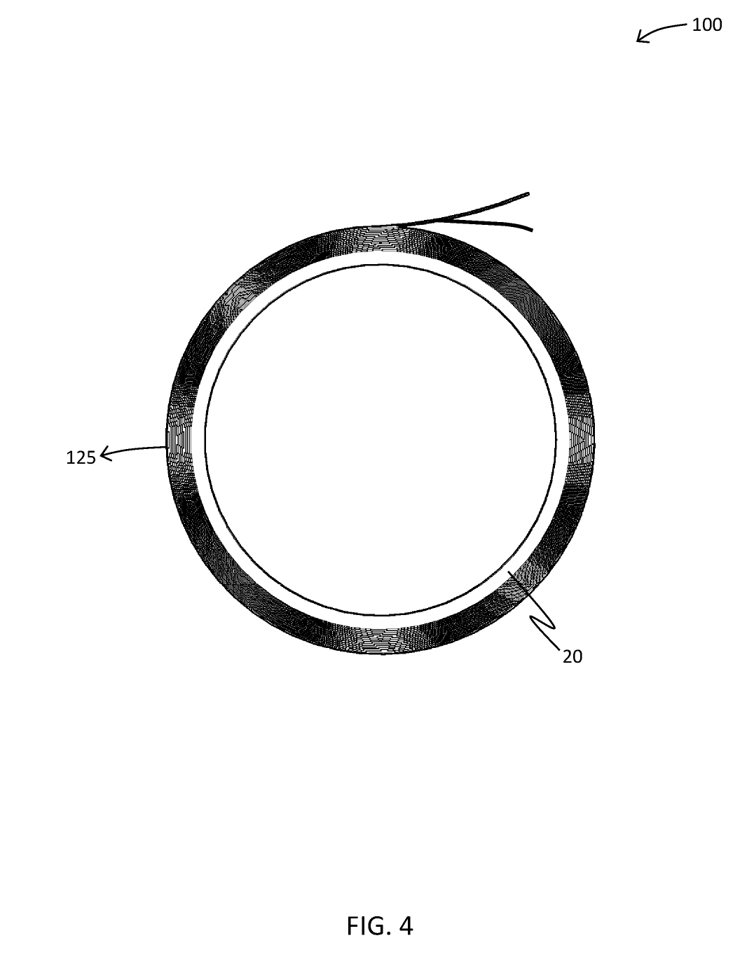

Referring now to FIG. 4 is a side view of the adhesive system 100 of FIG. 1, according to an embodiment of the present disclosure. The outer non-stick protective layer 110, the top adhesive layer 120, the middle support textile 130, and the bottom adhesive layer 140 may be configured to wind around a center cylindrical base 20. A portion of the bottom adhesive layer 140 may then be removably attached to the outer non-stick protective layer 110 of a next concentric layer 125.

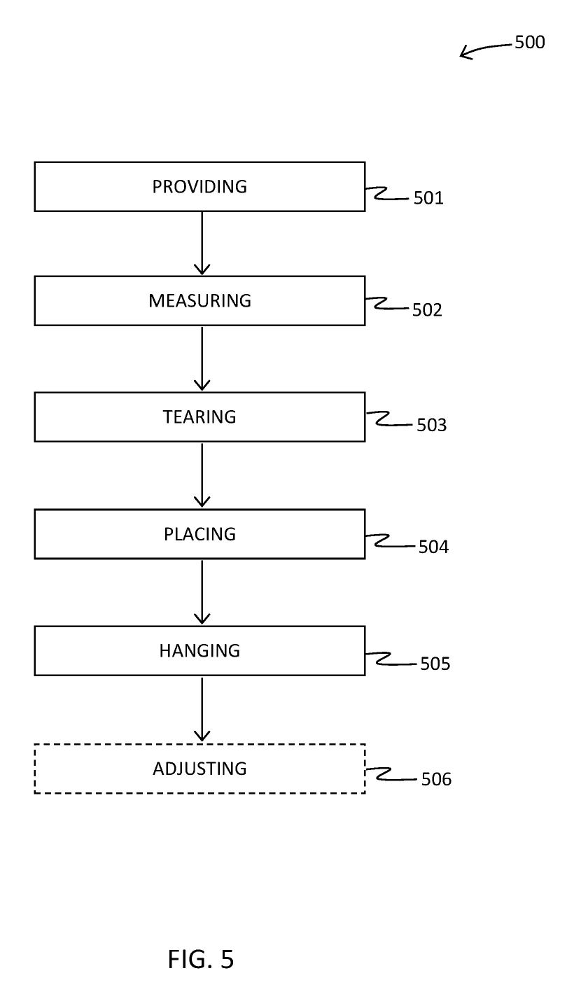

FIG. 5 is a flow diagram illustrating a method for using 500 a non-destructive adhesive system 100, according to an embodiment of the present disclosure. In particular, the method for using 500 a non-destructive adhesive system 100 may include one or more components or features of the adhesive system 100 as described above. As illustrated, the method for using 500 a non-destructive adhesive system 100 may include the steps of: step one 501, providing a non-destructive adhesive system; step two 502, measuring a section of the non-destructive adhesive system; step three 503, tearing off the section of the non-destructive adhesive system; step four 504, placing the section of the non-destructive adhesive system on an item; step five 505, hanging the item once the non-destructive adhesive system is placed; and step six 506, adjusting the non-destructive adhesive system.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a non-destructive adhesive system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An adhesive system comprising:
an outer non-stick protective layer;
a top adhesive layer removably coupled to a bottom of the outer non-stick protective layer;
a middle support textile fixedly attached to a bottom of the top adhesive layer; and
a bottom adhesive layer fixedly attached to a bottom of the middle support textile;
wherein the outer non-stick protective layer, the top adhesive layer, the middle support textile, and the bottom adhesive layer are configured to wind around a center cylindrical base; a portion of the bottom adhesive layer is then removably attached to the outer non-stick protective layer of a next concentric layer; and
wherein the adhesive system is configured to be dispensed from an outermost layer to an innermost layer from the center cylindrical base.

2. The system of claim 1, wherein the top adhesive layer is configured to have sufficient tensile strength to hold a sheet of paper.

3. The system of claim 2, wherein the top adhesive layer is configured to be easily reportioned without damaging a surface where the top adhesive layer is attached.

4. The system of claim 2, wherein the bottom adhesive layer is configured to have sufficient tensile strength to hold a sheet of paper.

5. The system of claim 4, wherein the bottom adhesive layer is configured to be easily reportioned without damaging the surface where the bottom adhesive layer is attached.

6. The system of claim 1, wherein the outer non-stick protective layer is configured to include functional indicia.

7. The system of claim 6, wherein the functional indicia of the outer non-stick protective layer is configured to represent standard measurement markings.

8. The system of claim 1, wherein the adhesive system is configured to be of sufficient length to hold at least three feet of the adhesive system.

9. The system of claim 1, wherein the adhesive system is configured to be easily cut in desired user-determined lengths.

10. The system of claim 1, wherein the adhesive system is reusable.

11. The system of claim 1, wherein the adhesive system is configured to be designed with non-toxic material.

12. The system of claim 1, wherein the adhesive system is configured to be dispensed in one continuous length.

13. The system of claim 12, wherein the adhesive system is configured to be dispensed in measured sections.

14. The system of claim 13, wherein the measured sections are configured to coincide with the standard measurement markings.

15. The system of claim 14, wherein the middle support textile is configured to be perforated for easy removal when the adhesive system is configured in the measured sections.

16. The system of claim 1, wherein the perforation of the middle support textile is configured to run perpendicular to the adhesive system.

17. A non-destructive adhesive system comprising:
an outer non-stick protective layer wherein the outer non-stick protective layer is configured to include functional indicia and is configured to represent standard measurement markings;
wherein the adhesive system is configured to be dispensed in measured sections that coincide with the standard measurement markings;
a top adhesive layer removably coupled to a bottom of the outer non-stick protective layer;
wherein the top adhesive layer is configured to have sufficient tensile strength to hold a sheet of paper and is configured to be easily reportioned without damaging a surface where the top adhesive layer is attached;
a middle support textile fixedly attached to a bottom of the top adhesive layer;
wherein the middle support textile is configured to be perforated for easy removal when the adhesive system is configured in the measured sections with the perforation running perpendicular to the adhesive system; and
a bottom adhesive layer fixedly attached to a bottom-side of the middle support textile;
wherein the bottom adhesive layer is configured to have sufficient tensile strength to hold the sheet of paper and is configured to be easily reportioned without damaging the surface where the bottom adhesive layer is attached;
wherein the outer non-stick protective layer, the top adhesive layer, the middle support textile, and the bottom adhesive layer are configured to wind around a center cylindrical base; a portion of the bottom adhesive layer is then removably attached to the outer non-stick protective layer of a next concentric layer;
wherein the adhesive system is configured to be designed with non-toxic material and reusable; and
wherein the adhesive system is configured to be dispensed from an outermost layer to an innermost layer from the center cylindrical base and configured to be of sufficient length to hold at least three feet of the adhesive system and is configured to be easily cut in desired user-determined lengths.

18. The system of claim 17, further comprising set of instructions; and
wherein the system is arranged as a kit.

19. A method for using a non-destructive adhesive system, the method comprising the steps of:
providing a non-destructive adhesive system;
measuring a section of the non-destructive adhesive system;
tearing off the section of the non-destructive adhesive system;
placing the section of the non-destructive adhesive system on an item; and
hanging the item once the non-destructive adhesive system is placed.

20. The method of claim 19, further comprising the step of:
adjusting the non-destructive adhesive system.
